(19) United States
(12) Patent Application Publication
(10) Pub. No.: US 2023/0157282 A1
(43) Pub. Date: May 25, 2023

(54) Synergistic Preservative/Personal Care Composition With A Polyglycerol Ester

(71) Applicants: ARCH UK BIOCIDES LTD, Castleford, West Yorkshire (GB); ARXADA, LLC, Morristown, NJ (US)

(72) Inventors: James Clarke, Castleford, West Yorkshire (GB); Jake Campbell, Castleford, West Yorkshire (GB); Philip Lewis Roebuck, Castleford, West Yorkshire (GB); Neil Scott Shaw, Castleford, West Yorkshire (GB); Angela Sangirardi, Morristown, NJ (US)

(21) Appl. No.: 17/920,172

(22) PCT Filed: Apr. 22, 2021
(86) PCT No.: PCT/EP2021/060553

§ 371 Date: Oct. 20, 2022

Related U.S. Application Data
(60) Provisional application No. 63/014,202, filed on Apr. 23, 2020.

(30) Foreign Application Priority Data
May 22, 2020 (EP) 20176133.5

(51) Int. Cl. A01N 37/12; A01N 43/40; A01N 59/16; A01P 1/00; A01N 37/10

(52) U.S. Cl. CPC A01N 37/12; A01N 43/40; A01N 59/16; A01P 1/00; A01N 37/10

(57) ABSTRACT

Provided herein are preservative composition of a preservative agent with a polyglycerol ester having a synergistic effect which allow for a reduction in the amount of the preservative agent necessary to be an effective preservative in an end-use formulation.

### FIELD OF INVENTION

The present disclosure relates to a preservative composition containing a preservative agent and a potentiator ingredient with enhance preservative properties as compared with a preservative composition with a preservative agent itself.

### BACKGROUND OF THE INVENTION

Microbial contamination of personal care products, cosmetics, home care products and other similar products is a matter of great importance to the industry and it can become a major cause of both product losses of end-use formulations and economic losses. Moreover, the contamination of cosmetics and home care products can result in their being converted into products hazardous for consumers. Preservative agents and preservative compositions for protecting and preserving end-use formulations against microbial attack from bacterial or fungal are known in the art. These preservative agents and compositions have a wide variety of applications in fields such as personal care products, cosmetics, home care products, and health and hygiene products. Conventional preservative agents and compositions have used traditional active ingredients which provide good bacterial and fungicidal properties against microbial attack.

Ideally, a preservative agent or composition has broad-spectrum activity against all types of microorganisms at various pH levels. The preservative agent or composition should also have high efficacy so that a minimum amount of the preservative can be used to save cost and to avoid or reduce any possible adverse effects caused by the preservative agent or preservative agents in the preservative composition. Also, it is desirable that the preservative agent or composition is stable to any changes in temperature encountered during manufacturing, packaging, and shipping as well as during storage of the end-formulation in which the preservative agent or compositions is placed. Further, an ideal preservative agents or components of a preservative composition is physically and chemically compatible with ingredients present in various end-use formulations so that one preservative agent or preservative compositions can suitably be incorporated in various products.

In recent developments in the preservative arts, there has been considerable effort given to find compounds that will synergistically interact with the preservative agent(s) in order to boost the efficacy of the preservative agent(s) and/or to effectively reduce the amount of preservative agent(s) needed in a preservative to have a desired preservation properties, while using the least amount of the preservative agent(s) to achieve the desired level of preservation. This is a result of continued regulatory pressures to reduce the amount of the preservative agent(s) in end-use formulations.

Similarly, in the field of personal care formulations containing an active agent to treat specific conditions, such as dandruff, there is ongoing regulatory pressures to reduce the amount of the active ingredient in personal care formulations. One way to reduce the amount of the active ingredients is to increase the active ingredients efficacy in the personal care formulation, forming a synergistic mixture of an active ingredient with a potentiator, which increases the efficacy of the active ingredient.

The present disclosure provides an answer to that need, by providing a synergistic mixture of a preservative agent with a polyglycerol ester compound which can be used in various compositions as a preservative, including personal care formulation.

### SUMMARY OF THE INVENTION

In one aspect, provided is a preservative composition containing a (i) preservative agent; and (ii) a polyglycerol ester, wherein the polyglycerol ester is present in an amount to sufficiently increase the efficacy of the preservative agent as compared to the preservative agent alone, and the increase is greater than the additive effect of the biocidal activity of the preservative agent and polyglycerol ester taken alone.

In another aspect, provided is a preservative composition according wherein the weight ratio of the polyglycerol ester to the preservative agent is in the range of 0.00001 to 10.0; particularly in the range of 0.0001 to 2.0; more particularly in the range of 0.001 to 1.5; and most particularly in the range of 0.01 to 1.0.

In another aspect, the preservative composition has a preservative agent which is an acid compound, an aldehyde, a phenolic compound, a sulfite, an iron chelator, an aromatic alcohol, a quaternary ammonium compound, a pyrone compound, an urea compound, an imidazole compound, an isothiazolinone compound, or a combination of two or more preservative agents.

In a particular aspect, the preservative composition has a preservative agent containing an iron chelator, said iron chelator comprises a pyrithione compound, piroctone olamine, 2-pyridinol-1-oxide, N-hydroxy-6-octyloxypyridine 2(1H)-one, -hydroxy-6-octyloxypyridine 2(1H)-one ethanolamine salt or a mixture thereof. Particular pyrithione compounds include zinc pyrithione, sodium pyrithione or mixtures thereof.

In an embodiment of the present disclosure, the wherein the preservative agent is an acid compound. The acid compound may be an acid, an ester of an acid or a salt of an acid. In a particular embodiment, the acid compound comprises benzoic acid, propionic acid, salicylic acid, sorbic acid, formic acid, undec-10-enoic so acid, lactic acid, glycolic acid, and citric acid, or a salt thereof.

In another embodiment, the preservative agent is a quaternary ammonium compound. Particular quaternary ammonium compounds include an alkyl (C12-22) trimethyl ammonium compound, a benzethonium compound, or a mixture thereof.

In a further embodiment, the preservative agent comprises an alcohol. Alcohols include lower alkyl alcohols or an aromatic alcohols. A particular aromatic alcohol is phenoxy ethanol and a particular lower alcohol is isopropanol.

In another aspect, provided is a preservative composition where the polyglycerol ester is a polyglycerol fatty esters derived from (a) a polyglycerol component built up from 2 to 12 molecules of glycerol, based on an average, and (b) a fatty acid comprises a caprylic acid, capric acid, lauric acid, myristic acid, palmitic acid, stearic acid, arachidic acid, behenic acid, lignoceric acid, cerotic acid, oleic acid, or decaoleic acid. Particular examples of such polyglyceryl fatty esters include one or more of a polyglyceryl-10 laurate, polyglyceryl-10 decaoleate; polyglyceryl-3 monostearate; polyglyceryl-6 distearate, polyglyceryl-10 stearate; polyglyceryl-10 oleate; polyglyceryl-10 dipalmitate, or polyglyceryl-10 caprylate/caprate.

In another aspect of the present disclosure, provided is method for increasing the efficacy of a preservative agent in an end-use formulation. The method contains the steps of providing a preservative agent and an effective amount of a polyglycerol ester. Adding the preservative agent and the polyglycerol ester to an end-use Zoo formulation to increase the efficacy of the preservative agent, in the end-use formulation, as compared to an equal amount of preservative agent without the polyglycerol ester. The polyglycerol ester may be added to the preservative agent prior to the addition of the preservative agent to the end-use formulation, after the preservative agent is added to the end-use formulation, prior to the addition of the preservative agent to the end-use formulation, or concurrently with the preservative agent to the end-use formulation.

In a further aspect of the present disclosure, provided is a method of increasing the resistance of an end-use formulation to biological attack. The method has the steps of providing a cosmetic formulation and adding a preservative composition in any one of the previous aspects or embodiments to the cosmetic formulation. By adding the preservative composition, the end use composition has an increase resistance to biological attack as compared to a end-use formulation without the polyglycerol ester present in the preservative composition.

In a further aspect of the present disclosure, provided is a method of reducing the minimum amount preservative agent needed for effective preservation activity in an end-use formulation. The method has the steps of providing a preservative agent, and adding an amount of a polyglycerol ester to the preservative agent to form a preservative composition. The preservative composition is then added to an end-use formulation, wherein the minimum amount of the preservative agent needed for effective preservation activity in the end-use formulation is less than if the preservative agent was used alone.

In a further embodiment, provided is an end-use formulation containing a preservative composition of any of the prior embodiments. The end-use formulation may be a personal care formulation or a home care formulation.

These and other aspects will become apparent when reading the detailed description of the invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a preservative composition. As used herein, the term “preservative” means a biocidal agent or biocidal composition which is intended to be blended with into an end-use formulation, such as personal care formulations, cosmetics, home care formulations, and health and hygiene products, to prevent microorganisms from destroying the end-use formulation or making the end-use formulation unusable for the particular purpose the end-use formulation was developed.

It has now been surprisingly found that adding an amount of a polyglycerol ester to a preservative intended for end-use formulation can provide an effectively preserved end-use formulation with a synergistic interaction between the preservative and the polyglycerol ester. As used herein, a “synergistic interaction” refers to the fact that the preservative, when combined together the polyglycerol ester has a total antimicrobial/antifungal effect that is greater than the antimicrobial/antifungal properties of the preservative alone, or the polyglycerol ester alone. In other words, the preservative of the present disclosure operates synergistically with the polyglycerol ester so as to have greater antimicrobial/antifungal activity in the presence of each against a certain microorganisms than in comparison to the antimicrobial activity of the preservative alone or the antimicrobial activity of the polyglycerol ester alone at the same concentrations. Due to the synergistic effect, the amount of the preservative present in the preservative composition can be reduced while still producing the desired efficacy. This effect is also known as “potentiation” of the preservative agent in the preservative composition. This potentiation of the preservative agent is also referred to herein as a “synergistic effect” between the preservative agent and the polyglycerol esters for boosting the efficacy of the preservative agent.

As used herein, the term “salts thereof” are intended to include cations of sodium, potassium, calcium, magnesium, ammonium and ethanolamines and other similar cations, anions of chloride, bromine, acetate, sulfates and the other similar anions.

Suitable preservative agents usable in the present disclosure include, for example, acids, esters and their salts, aldehydes, phenolic compounds, sulfites and iron chelator, aromatic alcohols, quaternary ammonium compounds, aldehydes, pyrone compounds, urea compounds, imidazole compounds, isothiazolinones and combinations thereof.

In one embodiment, the preservative agent may be an acid compound, including both aromatic and non-aromatic acids. Exemplary acids include, for example, benzoic acid, propionic acid, salicylic acid, sorbic acid, formic acid, undec-10-enoic acid, lactic acid, glycolic acid, and citric acid. In addition, salts of these acids may also be used as well as esters of these acids. Examples of salts include sodium benzoate and potassium sorbate. Other salts may also be used. Acid compounds are typically used as preservatives in end-use formulations in amounts up to about 3% by weight, depending on the particular acid compound. Similar amounts may be used for the esters and salts. In most cases and used, the amount of the acid, ester or salts thereof are used in amounts up about 1% by weight, more typically up to about 0.6% by weight. Mixtures of acids may also be used as the preservative agent.

In another embodiment, the preservative agent may be an aldehyde. Exemplary aldehydes include, for example, formaldehyde and paraformaldehydes. Exemplary aldehyde forming agents include imidazolidine compounds like hydantoins, such as dimethylol dimethyl hydantoin, (DMDMH) and other similar aldehyde forming hydantoins. Depending on the use, the aldehydes may be present in the composition to be preserved in amounts up to 0.3% by weight. Typically, the amount of the aldehydes is up to 0.2% based on the weight of the composition to be preserved. Mixtures of aldehydes may also be used as the preservative agent.

In a further embodiment, the preservative agent may be a phenolic compounds. Exemplary phenolic compounds include, for example, paraben compounds, biphenyl-2-ol (o-phenylphenol) or salts thereof, 4-chloro-m-cresol, 5-Chloro-2-(2,4-dichlorophenoxy)phenol (triclosan), 4-Chloro-3,5-dimethylphenol, 4-isopropyl-m-cresol, 2-benzyl-4-chlorophenol, and bromchlorophen. Exemplary paraben compounds include, for example butyl paraben, propyl paraben, ethyl paraben, methyl paraben and salts thereof, including, for example, potassium, sodium and/or calcium salts. Phenolic compounds are typically used as preservatives in end-use formulation in amounts up to about 1% by weight, based on the weight of the total end-use formulation. This upper limits depends on the particular phenolic compound. More typically up to about 0.5% by weight of the phenolic compound is used in cosmetic formulations.

In yet another embodiment, the preservative agent may be a compound which is a known as an iron chelator. Exemplary iron chelators include pyrithione compounds and compounds such as piroctone olamine or hydroxyl pyridine zoo compounds and salts thereof. Pyrithione is known by several names, including 2 mercaptopyridine-N-oxide; 2-pyridinethiol-1-oxide (CAS Registry No. 1 121-31 -9); 1-hydroxypyridine-2-thione and 1 hydroxy-2(1H)-pyridinethione (CAS Registry No. 1 121-30-8); 2-pyridinol-1-oxide (HPNO) and N-hydroxy-6-octyloxypyridine 2(1H)-one and -hydroxy-6-octyloxypyridine 2(1H)-one ethanolamine salt. Pyrithione salts are commercially available from Lonza, Inc., such as Sodium OMADINE® or Zinc OMADINE®.

The pyrithione present as the preservative agent can be present in a water insoluble form or in a water soluble form. The pyrithione may comprise sodium pyrithione, zinc pyrithione, barium pyrithione, strontium pyrithione, copper pyrithione, cadmium pyrithione, and/or zirconium pyrithione. Other pyrithiones that may be present in the composition include sodium pyrithione, bismuth pyrithione, potassium pyrithione, lithium pyrithione, ammonium pyrithione, calcium pyrithione, magnesium pyrithione, silver pyrithione, gold pyrithione, manganese pyrithione, and/or an organic amine pyrithione. A single pyrithione may be present as the preservative agent or a combination of any of the above may be included as the preservative agent.

The pyrithione particles can have a particle size such that 100% of the particles have a particle size of less than about 10 microns and at least 70% of the particles have a particle size less than 5 microns, such as at least about 50% of the particles can have a particle size of 1 micron or less. Particle size can be measured using a laser scattering particle size analyzer, such as a HORIBA LA 910 particle size analyzer.

The pyrithione particles can be produced by reacting pyrithione or a water-soluble salt of pyrithione, and a water-soluble polyvalent metal salt in a pressurized, turbulent flow reactor that generates pulverizing forces. The pulverizing forces produced by the pressurized, turbulent flow reactor efficiently generate pyrithione salt particles of micron size. The micron-sized pyrithione salt particles made by the method have a narrow and uniform size distribution, and have excellent surface deposition properties due to the large surface area provided by the population of micron particles.

Iron chelator compounds are typically used as preservatives in end-use formulations in amounts up to about 1% by weight, depending on the particular compound. Of particular interest zinc pyrithione and piroctone olamine. These iron chelators may also have other advantages, including having other benefits in the formulation, including antidandruff properties in hair care products.

In another embodiment, the preservative agent may include inorganic sulfite compounds and hydrogen sulfites compounds. Sulfite compound are generally present in amounts up about 0.5% by weight, based on the total weight of the end-use formulation.

Another preservative agent useable in the present disclosure includes alcohol compounds. The alcohol may be a lower alcohol or an aromatic alcohol. Lower alcohols are typically selected among mono-functional low-molecular alcohols, preferably alkanols with one to four carbon atoms such as methanol, ethanol, isopropanol or butanol, or combinations thereof. Substituted alcohols, such a chlorobutanol may also be used. Particularly suitable lower alcohols include ethanol and isopropyl alcohol. Aromatic alcohols may also be used. Suitable aromatic alcohols include phenoxyethanol, 2,4-Dichlorophenyl)methanol, benzyl alcohol, 1-Phenoxypropaneol, chlorphenesin, and benzyl hemiformal. The alcohol compounds are typically used as preservative agents in end-use formulations in amounts up to about 1.5% by weight based on the total weight of the end-use formulation, depending on the particular alcohol compound. In most cases, the amount of the alcohol compounds are typically used in amounts up about 1% by weight, more typically up to about 0.5% by weight, based on the weight of the end-use formulation.

In another embodiment, quaternary ammonium compound may be used as preservative agent. Suitable quaternary ammonium compounds include, for example alkyl (C₁₂₋₂₂) trimethyl ammonium bromide, alkyl (C₁₂₋₂₂) trimethyl ammonium chloride compounds including, for example cetrimonium bromide, cetrimonium chloride, laurtrimonium bromoide, laurtrimonium chloride, steartrimonium bromide, and steartrimonium chloride or mixture thereof, benzethonium compound, including, for example benzalkonium chloride, benzalkonium bromide and benzalkonium saccharinate. The quaternary ammonium compounds are typically used as preservatives in end-use formulations in amounts up to about 0.2% by weight based on the total weight of the end-use formulation, depending on the particular quaternary ammonium compound. In most cases, the amount of the quaternary ammonium compounds are typically used in amounts up about 0.1% by weight, more typically up to about 0.05% by weight, based on the weight of the end-use formulation.

Exemplary pyrone compounds useable in the present disclosure as a preservative agent include, for example, dehydroacetic acid and salts thereof. Pyrone compounds may be used in amount up to about 1.0% by weight, based on the total weight of the cosmetic formulation. More typically, pyrone compound may be used in amounts up to about 0.6% by weight.

Exemplary isothiazolinones useable in the present disclosure as a preservative agent include, for example 5-chloro-2-methyl-isothiazol-3-one (chloromethylisothiazolinone), 2-methyl-isothiazol-3-one (methylisothiazolinone), benzisothiazolinone and mixtures thereof. These compounds are typically used in amounts up to about 0.01% by weight of the end-use formulation.

Exemplary urea compounds useable in the present disclosure as the preservative agent include, for example, 3-(4-Chlorophenyl)-1-(3,4-dichlorophenyl)urea (triclocarban); 1,1′-methylenebis{3-[4-(hydroxymethyl)-2,5-dioxoimidazolidin-4-yl]urea}; and N-(hydroxymethyl)-N-(dihydroxymethyl-1,3-dioxo 2,5-imidazolinidyl-4)-N′-(hydroxymethyl) urea. These compounds are typically used in amounts up to about 0.5% by weight of the end-use formulation.

Exemplary imidazole compounds useable in the present disclosure as the preservative agent include, for example, 1-(4-chlorophenoxy)-1-(imidazole-1-yl)-3,3-dimethylbutan-2-one); 1,3-Bis(hydroxymethyl)-5,5-dimethylimidazolidine-2,4-dione). These compounds are typically used in amounts up to about 0.5% by weight of the end-use formulation.

Other components that may be used as a preservative agent include dibromohexamidine and salts thereof; thiomersal; phyenylmercuric salts; hexetidine; 2-bromo-2-nitropropane-1,3-diol; 5-bromo-5-nitro-1,3-dioxane; polyhexamethylenebiguanide or salts thereof; hexamethylenetetramine; methenamine 3-chloroallylochloride; 2-chloroacetamide; chlorohexidine and its diglucononate, or diacetate esters and dihydrochloride salt thereof; 4,4-dimethyl, 1,3-oxazolidine; glutaraldehyde; 5-ethyl-3,7-dioxa-1-azabicyclo octane; Sodium hydroxymethylglycinate, 3-Iodo-2-propynyl butylcarbamate (IP BC) and ethyl lauroyl alginate. These compounds are typically used in amounts up to about 0.5% by weight of the end-use formulation.

In addition, the preservative agent may be a single preservative agent, a mixture of two or more preservative agents from a single type of preservative agent or may be a mixture of two or more different types of preservative agents.

In an embodiment, polyglycerol esters useable in the present disclosure may be formed from saturated, unsaturated, natural or synthetic fatty acids, and the like. For instance, saturated fatty acids include caprylic acid, capric acid, lauric acid, myristic acid, palmitic acid, stearic acid, arachidic acid, behenic acid, lignoceric acid, cerotic acid, combinations thereof, derivatives thereof, and the like. Furthermore, the polyglycerol esters are derived from (a) a polyglycerol component built up from 2 to 12 molecules of glycerol, based on an average, and (b) a fatty acid selected from the group consisting of caprylic acid, capric acid, lauric acid, myristic acid, palmitic acid, stearic acid, arachidic acid, behenic acid, lignoceric acid, cerotic acid, oleic acid, decaoleic acid, mixtures thereof and the like.

Examples of polyglycerol esters useable in the present disclosure, include but are not limited to, polyglyceryl monodecaoleate such as polyglyceryl-10 decaoleate; polyglyceryl monooleate such as polyglyceryl-2-monooleate, polyglyceryl-3 monooleate, polyglyceryl-4 monooleate, polyglyceryl-6 monooleate, or polyglyceryl-10 monooleate; polyglyceryl dioleate such as polyglyceryl-2 dioleate, polyglyceryl-3 dioleate, polyglyceryl-5 dioleate, polyglyceryl-6 dioleate or polyglyceryl-10 dioleate; polyglyceryl trioleate such as polyglyceryl-5 trioleate or polyglyceryl-10 trioleate; polyglyceryl tetraoleate such as polyglyceryl-2 tetraoleate, polyglyceryl-6 tetraoleate, or polyglyceryl-10 tetraoleate; polyglyceryl pentaoleate such as polyglyceryl-4 pentaoleate, polyglyceryl-6 pentaoleate, or polyglyceryl-10 pentaoleate; polyglyceryl heptaoleate such as polyglyceryl-6 heptaoleate, polyglyceryl-10 heptaoleate; polyglyceryl monostearate such as polyglyceryl-2 monostearate, polyglyceryl-3 monostearate, polyglyceryl-4 monostearate, polyglyceryl-5 monostearate, polyglyceryl-6 monostearate or polyglyceryl-10 monostearate; polyglyceryl distearate such as polyglyceryl-2 distearate, polyglyceryl-3 distearate, polyglyceryl-4 distearate, polyglyceryl-6 distearate, or polyglyceryl-10 distearate; polyglyceryl tristearate such as polyglyceryl-4 tristearate, polyglyceryl-5 tristearate, polyglyceryl-6 tristearate, or polyglyceryl-10 tristearate; polyglyceryl tetrastea rate such as polyglyceryl-2 tetrastearate; polyglyceryl pentastearate such as polyglyceryl-4 pentastearate, polyglyceryl-6 pentastearate, or polyglyceryl-10 pentastearate; polyglyceryl heptastearate such as polyglyceryl-10 heptastearate; polyglyceryl isostearate such as polyglyceryl-2 isostearate, polyglyceryl-3 isostearate, polyglyceryl-4 isostearate, polyglyceryl-6 isostearate, or polyglyceryl-10 isostearate; polyglyceryl diisostearate such as polyglyceryl-2 diisostearate. polyglyceryl-3 diisostearate, polyglyceryl-4 diisostearate, polyglyceryl-6 diisostearate, polyglyceryl-10 diisostearate, or polyglyceryl-15 diisostearate; polyglyceryl triisostearate such as polyglyceryl-2 triisostearate, polyglyceryl-3 triisostearate, polyglyceryl-5 triisostearate, polyglyceryl-10 triisostearate; polyglyceryl tetraisostearate such as polyglyceryl-2 tetraisostearate; polyglyceryl caprylate such as polyglyceryl-2 caprylate, polyglyceryl-3 caprylate, polyglyceryl-4 caprylate, polyglyceryl-6 caprylate, or polyglyceryl-10 caprylate; polyglyceryl dicaprylate such as polyglyceryl-5 dicaprylate; polyglyceryl sesquicaprylate such as polyglyceryl-2 sesquicapyrlate; polyglyceryl octacaprylate such as polyglyceryl-6 octacaprylate; polyglyceryl caprate such as polyglyceryl-2 caprate, polyglyceryl-3 caprate, polyglyceryl-4 caprate, polyglyceryl-5 caprate, polyglyceryl-6 caprate, polyglyceryl-10 caprate, polyglyceryl dicaprate such as polyglyceryl-3 dicaprate or polyglyceryl-6 dicaprate; polyglyceryl caprylate/caprate such as polyglyceryl-4 capyrlateicaprate, polyglyceryl-6 caprylate/caprate, or polyglyceryl-10 caprylate/caprate; polyglyceryl palmitate such as polyglyceryl-2 palmitate, polyglyceryl-3 palmitate, polyglyceryl-6 palmitate or polyglyceryl-10 palmitate; polyglyceryl dipalmitate such as polyglyceryl-6 dipalmitate or polyglyceryl-10 dipalmitate; polyglyceryl tetrabehenate such as polyglyceryl-6 tetrabehenate; polyglyceryl myristate such as polyglyceryl-6 myristate or polyglyceryl-10 myristate; polyglyceryl rincinoleate such polyglyceryl-6 polyricinoleate or polyglyceryl-10 ricinoleate; or mixtures thereof, other complexes or derivatives thereof, and the like.

Suitably, the polyglycerol ester may be one or more of a polyglyceryl-10 decaoleate, polyglyceryl-3 monostearate, polyglyceryl-6 distearate, polyglyceryl-10 stearate, polyglyceryl-10 oleate, polyglyceryl-10 dipalmitate, polyglyceryl-10 caprylate/caprate; and a mixture thereof. In one aspect, the polyglycerol ester is polyglyceryl-10 caprylate/caprate.

In the present disclosure, the weight ratio of the polyglycerol ester (PGE) to the preservative agent (PA) is typically in the range of about 0.00001 to about 10.0 (PGE/PA). As used herein, the “weight ratio” is calculated by dividing the amount of polyglycerol ester by the amount of preservative agent (e.g. a weight ratio of 10 is the same as 10 PGE:1 PA). More typically, the weight ratio of the polyglycerol ester (PGE) to the preservative agent (PA) is typically in the range of about 0.0001 to about 2.0, more typically in the range of 0.001 to 1.5 and ever more particularly 0.01 to 1.0. The weight ratio of the PGE to PA may be in any amount between the minimum and the maximum. For Example, the ratio may be between 0.00001 to 2.0; 0.0001 to 1.5; 0.00001 to 1; 0.00001 to 0.5; 0.0001 to 10; 0.0001 to 1.5; 0.0001 to 1; 0.0001 to 0.5; 0.001 to 10; 0.001 to 1.5; 0.001 to 1; 0.001 to 0.5; 0.01 to 10; 0.01 to 1.5; 0.01 to 1; 0.01 to 0.5.

The amount of the preservative agent used in the end-use formulation of the present disclosure varies, as described above, depending on the particular preservative agents. In an alternative embodiment, the preservative agent may be formulated in the form of a preservative concentrate. By “preservative concentrate” or “preservative composition” it is meant a composition which is to be added to an end-use formulation in a specified amounts. In the preservative concentrate, the amount of the preservative agent will be higher than typical final use amounts. The preservative concentrate may have only the preservative agent and the polyglycerol ester. Alternatively, the preservative concentrate may contain the preservative agent, the polyglycerol ester and a carrier that is compatible with end-use formulations. Exemplary carriers include, for example, an aqueous solvent which may be used is water, or other solvents acceptable for end-use formulations and uses of these formulations. Typically, the preservative concentrate will be added to end-use formulation in an amount necessary to achieve the desired amount of the preservative in the final end-use formulation.

When contained in a preservative concentrate, the preservative agent and the polyglycerol ester may be combined with various different components. For instance, in one embodiment, a solvent can be present in the product. Generally, the solvent will be a polar solvent such as water, or a water-miscible solvent, such as an alcohol and/or a glycol ether. In addition to water, the anti-microbial composition can further include a water-miscible organic solvent. Examples of water-miscible solvents include ethanol, propanol, benzyl alcohol, isopropanol, diethylene glycol propyl ether, ethylene glycol monomethyl ether, ethylene glycol monoethyl ether, ethylene glycol monopropyl ether, ethylene glycol monoisopropyl ether, ethylene glycol monobutyl ether, diethylene glycol monomethyl ether, diethylene glycol monobutyl ether, diethylene glycol monoethyl ether, diethylene glycol mono-n-butyl ether, ethylene glycol dimethyl ether, ethylene glycol diethyl ether, ethylene glycol dibutyl ether, propylene glycol n-butyl ether, tripropylene glycol methyl ether, dipropylene glycol methyl ether, dipropylene glycol butyl ether and combinations thereof.

In other embodiments, the polyglycerol ester and the preservative agent may be added to the end-use formulations independent of each other. That is the polyglycerol ester may be added to the preservative agent prior to the addition of the preservative agent to the end-use formulation, after the preservative agent is added to the end-use formulation, prior to the addition of the preservative agent to the end-use formulation, or concurrently with the preservative agent to the end-use formulation as separate ingredients.

Various different microorganisms may be controlled in accordance with the present disclosure. For instance, the preservative composition of the present disclosure can control gram positive bacteria, gram negative bacteria, and the like. In addition to bacteria, the preservative composition of the present disclosure can also kill and control the growth of various other microorganisms, such as viruses, spores, mycobacteria, and the like. Examples of particular microorganisms that may be controlled in accordance with the present disclosure include Staphylococcus aureus, Streptococcus pneumoniae, Pseudomonas aeruginosa, Serratia marcescens, Salmonella enteritidis, Neisseria gonorrhoeae, Escherichia coli, Enterococcus hirae, Acinetobacter baumannii, Listeria monocytogenes, Enterobacter gergoviae, Klebsiella pneumoniae, Burholderia cepacia, Pseudomonas putida, Kocuria rhizophila, Candida albicans, Saccharomyces cerevisiae, Aspergillus brasiliensis, Penicillium funiculosum, Eupenicillium levitum, Bacillus cereus, Bacillus subtilis, Clostridium difficile, Clostridium perfringens, Mycobacterium tuberculosis, Mycobacterium terrae, Mycobacterium avium, Poliovirus, Adenovirus, Norovirus, Vaccinia virus, Influenza virus, Hepatitis B virus, Human Immunodeficiency virus, Human papilloma virus, or mixtures thereof.

In general, the preservative composition of the present disclosure can be incorporated into any many different end-use formulations or products. As used herein, “end-use formulations” or “end use products” is intended to mean personal care products, including cosmetics, home care products, and health and hygiene products. For instance, the personal care product may comprise a cosmetic formulation, such as a face cream, makeup remover, mascara or wet wipe. The personal care product formulation may also comprise shampoo, a conditioner, skin lotion or liquid for any personal care wet wipe application. The personal care product formulation may comprise any product for topical application to a user's skin or hair. When combined with the personal care product formulation as a preservative, the composition has effective broad spectrum preservation activity over a broad pH range. For instance, the pH of the composition and/or of the personal care product can be generally greater than about 2 and less than about 9, such as from about 3 to about 8, particularly from about 3 to about 6.

The preservative composition may be incorporated into home care products as well, such as hand-dish soaps, laundry detergents, cleaning wipes, all purpose cleaners and other similar formulations that are used around the home.

The personal care product formulation generally comprises a base formulation to which the preservative composition of the present disclosure is added. The base formulation may contain numerous and different ingredients depending upon the end use application. The personal care product formulation, for instance, may contain solvents, surfactants, emulsifiers, consistency factors, conditioners, emollients, skin caring ingredients, moisturizers, thickeners, humectants, fillers, anti-oxidants, other preservatives, active ingredients, in particular dermatologically active ingredients, fragrances and the like, as well as mixtures thereof. Active ingredients as mentioned herein comprise, for example, anti-inflammatories, anti-bacterials, anti-fungals and the like agents. Active ingredients suited for topical applications are particularly preferred.

Suitable surfactants comprise: alkyl sulfates e.g. sodium lauryl sulfate, ammonium lauryl sulfate; sodium cetearyl sulfate; alkyl sulfoacetates e.g. sodium lauryl sulfoacetate; alkyl ether sulfates e.g. sodium laureth sulfate; sodium trideceth sulfate; sodium oleth sulfate; ammonium laureth sulfate; alkyl ether sulfosuccinates e.g. disodium laureth sulfosuccinate; alkyl glycosides e.g. decyl glucoside; lauryl glucoside; alkyl isethionates amphoterics e.g. cocamidopropyl betaine; sodium cocoamphoacetate; sodium lauroamphoacetate; disodium lauroamphodiacetate; disodium cocoamphodiacetate; sodium lauroamphopripionate; disodium lauroamphodipropionate; potassium or ammonium salts of the aforementioned amphoterics; capryl/capramidopropyl betaine; undecylenamidopropyl betaine; lauromidopropyl betaine; and fatty alcohol polyglycol ethers.

Suitable emulsifiers are e.g. anionics as salts of fatty acids e.g. sodium stearate or sodium palmitate, organic soaps e.g. mono-, di- or triethanolaminoeate, sulfated or sulfonated compounds e.g. sodium lauryl sulfate or sodium cetyl sulfonate, saponines, lamepones; cationics as quaternary ammonium salts; nonionics as fatty alcohols, fatty acid ester with saturated or unsaturated fatty acids, polyoxyethylenesters or polyoxyethylenethers of fatty acids, polymers from ethylene oxide and propylene oxide or propylene glycol, amphotherics as phosphatides, proteins as gelatine, casein alkylamidobetaines, alkyl betaines and amphoglycinates, alkyl phosphates, alkylpolyoxyethylene phosphates or the corresponding acids, silicone derivatives, e.g. alkyl dimethiconecoplyol.

Suitable consistency factors are e.g. fatty alcohols or their mixtures with fatty acid esters, e.g. acetylated lanolin alcohol, aluminum stearates, carbomer, cetyl alcohol, glyceryl oleate, glyceryl stearate, glyceryl stearate (and) PEG 100 stearate, magnesium stearate, magnesium sulfate, oleic acid, stearic acid, stearyl alcohol, myristyl myristate, isopropyl palmitate, beeswax and synthetic equivalents thereof, carbomers, and the like. Suitable conditioners are e.g. alkylamido ammonium lactate, cetrimonium chloride and distearoylethyl hydroxyethylmonium methosulfate and cetearyl alcohol, cetyl dimethicone, cetyl ricinoleate, dimethicone, laureth-23, laureth-4, polydecene, retinyl palmitate, quaternized protein hydrolysates, quaternized cellulose and starch derivatives, quaternized copolymers of acrylic or methacrylic acid or salts, quaternized silicone derivatives.

Suitable emollients are e.g. cetearyl isononanoate, cetearyl octanoate, decyl oleate, isooctyl stearate, coco caprylate/caprate, ethylhexyl hydroxystearate, ethylhexyl isononanoate, isopropyl isostearate, isopropyl myristate, oleyl oleate, hexyl laurate, paraffinum liquidum, PEG-75 lanolin, PEG-7 glyceryl cocoate, petrolatum, ozokerite cyclomethicone, dimethicone, dimethicone copolyol, dicaprylyl ether, butyrospermum parkii, buxus chinensis, canola, carnauba cera, copernicia cerifera, Oenothera biennis, Elaeis guineensis, Prunus dulcis, squalane, Zea mays, glycine soja, Helianthus annuus, lanolin, hydrogenated castor oil, hydrogenated coconut oil, hydrogenated polyisobutene, sucrose cocoate, stearoxy dimethicone, lanolin alcohol, isohexadecane.

Suitable skin care ingredients are e.g. plant extracts, bisabolol, anti-inflammatory agents, urea, allantoin, panthenol and panthenol derivatives, phytantriol, vitamins A, E, C, D, ceramides of animal or plant origin, lecithins, and the like.

Suitable moisturizers are e.g. butylenes glycol, cetyl alcohol, dimethicone, dimyristyl tartrate, glucose glycereth-26, glycerin, glyceryl stearate, hydrolyzed milk protein, lactic acid, lactose and other sugars, laureth-8, lecithin, octoxyglycerin, PEG-12, PEG 135, PEG-150, PEG-20, PEG-8, pentylene glycol, hexylene glycol, phytantriol, poly quaternium-39 PPG-20 methyl glucose ether, propylene glycol, sodium hyaluronate, sodium lactate, sodium PCA, sorbitol, succinoglycan, synthetic beeswax, tri-C14-15 alkyl citrate, starch.

Suitable thickeners are e.g. acrylates/steareth-20 methacrylate copolymer, carbomer, carboxymethyl starch, cera alba, dimethicone/vinyl dimethicone crosspolymer, propylene glycol alginate, hydroxyethylcellulose, hydroxypropyl methylcellulose, silica, silica dimethyl silylate, xanthan gum, hydrogenated butylenes/ethylene/styrene copolymer.

Suitable humectants are e.g. adipic acid, fumaric acid and its salts, benzoic acid and its salts, glycerine triacetate, sodium or magnesium lauryl sulfate, magnesium stearate, solid polyethylenglycol, polyvinylpyrrolidone, boric acid, mono-laurate or mono-palmitate, myristyl alcohol, cetyl alcohol, cetylstearyl alcohol, talcum, calcium or magnesium salts of higher fatty acids, mono-, di- or triglycerides of higher fatty acids, polytetrafluorethylene.

Suitable antioxidants are e.g. sulfites, e.g. sodium sulfite, tocopherol or derivates thereof, ascorbic acid or derivates thereof, citric acid, propyl gallate, chitosan glycolate, cysteine, N-acetyl cysteine plus zinc sulfate, thiosulfates, e.g. sodium thiosulfate, polyphenols and the like.

The formulations may further contain active ingredients, e.g. antimicrobials, anti-inflammatories, plant extracts, bisabolol, panthenol, tocopherol, actives for anti-stinging, anti-irritant or anti-dandruff applications, or anti-aging agents such as retinol, melibiose and the like. Other suitable actives are e.g. Medicago officinalis, Actinidia chinensis, allantoin, Aloe barbadensis, Anona cherimolia, Anthemis nobilis, Arachis hypogaea, Arnica Montana, Avena sativa, beta-carotene, bisabolol, Borago officinalis, butylenes glycol, Calendula officinalis, Camellia sinensis, camphor, Candida bombicola, capryloyl Glycine, Carica papaya, Centaurea cyanus, cetylpyridinium chloride, Chamomilla recutita, Chenopodium quinoa, Chinchona succirubra, Chondrus crispus, Citrus aurantium dulcis, Citrus grandis, Citrus limonum, Cocos nucifera, Coffea Arabica, Crataegus monogina, Cucumis melo, dichlorophenyl imidazoldioxolan, Enteromorpha compressa, Equisetum arvense, ethoxydiglycol, ethyl panthenol, farnesol, ferulic acid, Fragaria chiloensis, Gentiana 535 lutea, Ginkgo biloba, glycerin, glyceryl laurate, Glycyrrhiza glabra, Hamamelis virginiana, heliotropine, hydrogenated palm glycerides, citrates, hydrolyzed castor oil, hydrolyzed wheat protein, Hypericum perforatum, Iris florentina, Juniperus communis, Lactis proteinum, lactose, Lawsonia inermis, linalool, Linum usitatissimum, lysine, magnesium aspartate, Magnifera indica, Malva sylvestris, 540 mannitol, Melaleuca alternifolia, Mentha piperita, menthol, menthyl lactate, Mimosa tenuiflora, Nymphaea alba, olaflur, Oryza sativa, panthenol, paraffinum liquidum, PEG-20M, PEG-26 jojoba acid, PEG-26 jojoba alcohol, PEG-35 castor oil, PEG-40 hydrogenated castor oil, PEG-60 hydrogenated castor oil, PEG-8 caprylic/capric acid, Persea gratissima, petrolatum, potassium aspartate, potassium sorbate, propylene glycol, Prunus amygdalus dulcis, Prunus armeniaca, Prunus persica, retinyl palmitate, Ricinus communis, Rosa canina, Rosmarinus officinalis, Rubus idaeus, salicylic acid, Sambucus nigra, sarcosine, Serenoa serrulata, Simmondsia chinensis, sodium carboxymethyl betaglucan, sodium cocoyl amino acids, sodium hyaluronate, sodium palmitoyl praline, stearoxytrimethylsilane, stearyl alcohol, sulfurized TEA-ricinoleate, talc, Thymus vulgaris, Tilia cordata, tocopherol, tocopheryl acetate, trideceth-9, Triticum vulgare, tyrosine, undecylenoyl Glycine, urea, Vaccinium myrtillus, valine, zinc oxide, zinc sulfate.

The preservative composition of the present disclosure can be used in emulsions (both oil-in-water and water-in-oil), in aqueous solutions, in PIT (phase inversion temperature) emulsions, in oily solutions, in foaming cosmetic formulations (foams), and in so-called multiple emulsions, e.g. in triple emulsions (such as water/oil/water emulsions).

The preservative composition of the present disclosure can also be formulated as creams, gels, liquids or lotions. They can be used in hair care products such as shampoos, hair conditioners, hair dyes, hair tonic, hair gel, hair dressings, hair grooming aids and other hair care preparations; shaving applications such as shaving cream, aftershave lotions, and other shaving applications; personal cleaners for the body and hands, such as liquid bath soaps and detergents; fragrance preparations, such as perfumes, after bath splashes, and other similar fragrant preparations, skin care products, such as moisturizers, creams, and lotions and other similar skin care products, make-up products, such as mascara, base foundations and the like; make-up removal products, sun care products, indoor tanning products and other similar personal care products. One particular use of the present preservative composition as a preservative for formulations used to saturate wipes, used for personal cleaning and hygiene (for example baby wipes, wet toilet wipes, make-up removal wipes and exfoliating wipes the like. The preservative composition may also be used in other formulations where preservative agents are needed.

Typically, the preservative composition of the present disclosure may be added to an end-use formulation to be preserved in an amount between 0.01% to about 10% by weight of the formulation. More particularly, the preservative composition is added in an amount which is between about 0.1 and 5.0% by weight of the formulation. The amount of the preservative composition added is dependent on the preservative agent selected.

The preservative composition may also be used in wet wipe formulations that are used to saturate a wet wipe. The preservative composition serves to preserve the wet wipe formulation and the wipe prior to use. Once the wet wipe composition is formulated, the wet wipe composition is applied to a substrate.

The wet wipe composition with the preservative composition contained therein, may be applied to a substrate to be treated using conventional application techniques. Conventional techniques include spraying, pouring, squirting and/or wiping the formulation on a substrate. The composition is provided to the end user as a ready-to-use formulation or is provided to the end user in a container with an application means. For example, the composition may be provided in a container which is pressurized as an aerosol, a container with a trigger or pump sprayer, as a squirt container or conventional containers with a removable cap that allows the user to pour the formulation onto a substrate.

However, one particularly useful application means is to impregnate the formulation into a wiper substrate. In this embodiment, the wipe is a single use wipe that is impregnated with the formulation and is stored in a container that will dispense the wipe to a user. The container with the wipes may contain a single wipe, or several wipes. Suitable containers include a pouch containing a single wipe, such as a moist towelette which is torn open by the user, or may be a pouch with a resealable opening containing several wipes in a stacked fashion or other suitable formation that would allow a single wipe to be removed from the opening at a time. Pouches are generally prepared form a fluid impervious material, such as a film, a coated paper or foil or other similar fluid impervious materials. In another way to dispense wipes of the present invention is to place the wipe in to a fluid impervious container having an opening to access the wipes in the container. Containers may be molded plastic container with lids that are fluid impervious. Generally, the lid will have an opening to access the wipes in the container. The wipe in the container may in a interleaved stacked, such that as a wipe is removed from the container the next wipe is positioned in the opening of the container ready for the user to remove the next wipe. Alternatively, the wipe may be a continuous material which is perforated between the individual wipes of the continuous material. The continuous wipe material with perforations may be in a folded form or may be in a rolled form. Generally, in the rolled form, the wipe material is feed from the center of the rolled material. As with the interleaved stack, as a wipe is removed from the container, the next wipe is positioned in the opening for the use to remove the next wipe, when needed.

Disposable wipes provide advantages over other application vehicles, such as a reusable sponge, rag or the like. Unlike sponges, rags and the like, which are used repeatedly, the impregnated wipe is used a single time and disposed of.

The formulation is impregnated into the wipe such that the wipe is pre-moistened and will express or release the formulation on to the substrate as the wipe is run across the substrate to be treated. Generally, the formulation is saturated into the wipe such that the wipe will release the formulation to the substrate through the wiping action.

Suitable wipe substrates include woven and nonwoven materials. Essentially any nonwoven web material may be used. Exemplary nonwoven materials may include, but are not limited to meltblown, coform, spunbond, airlaid, airlaced, hydroentangled nonwovens, spunlace, bonded carded webs, and laminates thereof. The fibers used to prepare the wipe substrate may be cellulosic fiber, thermoplastic fibers and mixtures thereof. The fibers may also be continuous fibers, discontinuous fibers, staple fibers and mixtures thereof. Basis weights of the nonwoven web may vary from about 12 grams per square meter to 200 grams per square meter (gsm) or more.

In one embodiment, the substrate impregnated with the wiping composition contains significant amounts of cellulosic fibers. In particular, the wiping composition of the present disclosure is particularly well suited to protecting the cellulose substrate from attack by microorganisms that can contaminate the product. In one particular embodiment, for instance, the substrate may be made from greater than 80%, such as greater than 85%, such as greater than 90%, such as greater than 95%, such as even 100% by weight cellulose fibers. For examples, in one embodiment, the substrate is made from pulp fibers and a binder in an airlaced process. The basis weight of the substrate can be from about 20 gsm to about 100 gsm, such as from about 40 gsm to about 70 gsm, such as from about 50 gsm to about 60 gsm.

Once incorporated into the substrate, the resulting wiping product can have a weight ratio of liquid to substrate of from about 5:1 to about 1:1, such as from about 2:1 to about 4:1.

The following examples illustrate the invention without limitation. All parts and percentages are given by weight unless otherwise indicated.

It will be understood that each of the elements described in the examples below, or two or more together may also find a useful application in other types of methods differing from the type described above. Without further analysis, the foregoing will so fully reveal the gist of the present disclosure that others can, by applying current knowledge, readily adapt it for various applications without omitting features that, from the standpoint of prior art, fairly constitute essential characteristics of the generic or specific aspects of this disclosure set forth in the appended claims.

### EXAMPLES

To demonstrate the synergistic effect the follow example were performed.

Test Organism Preparation

The target organism Pseudomonas aeruginosa ATCC 15442 was taken from freezer stocks and grown for 24 hours on tryptone soy agar (TSA) at 37° C. A second subculture was produced from the first and grown with the same conditions. A test suspension was then created by adding loopfuls of organism to tryptone buffered saline and adjusting the cell concentration to 1×10⁸ and 5×10⁸ CFU/ml using an internally established calibration curve spectrophotometer at a wavelength of 600 nm. To establish the precise CFU/ml a 1 ml aliquot was then taken from the test suspension and serially diluted down to 10⁻⁶ and 10⁻⁷, 1 ml of each dilution was then plated in duplicate using the pour plate method on to TSA. The plates were then incubated for 24 hours at 37° C. and enumerated.

Test Sample Preparation

For each Active Ingredient tested a series of 3 samples were prepared in sterile distilled water;

Test sample 1—Active Ingredient alone (to measure basic efficacy of the Active Ingredient)

Test sample 2—Active Ingredient in combination with polyglyceryl-10 caprylate/caprate (to measure the efficacy of the combination of active ingredient and polyglycerol ester)

Control—A control sample of polyglyceryl-10 caprylate/caprate was prepared in deionized water to measure the efficacy of polyglycerol ester alone.

Each test sample was prepared at a concentration 10% higher than that of the target concentration to account for the dilution effect from the addition of the test organism suspension during the test procedure.

Test Procedure

A test mixture was prepared by adding a 0.1 ml aliquot of test organism suspension to a tube followed by 0.9 ml of test sample (prepared as above). The combination was then mixed and a timer started immediately. Each test mixture was allowed to sit for a specified contact time shown in Table 1.

TABLE 1
(Contact Times)

| Active Ingredient | Contact time | |
|---|---|---|
| Phenoxyethanol | 24 | hours |
| Benzothiazolinone | 48 | hours |
| Lactic acid | 3 | hours |
| Zinc pyrithione | 7 | days |
| Benzyl alcohol | 7 | days |
| Chlorhexidine | 5 | minutes |
| Benzoic acid | 2 | hours |
| Glycolic acid | 30 | minutes |

Upon achieving the specified contact time the test mixture was deactivated by adding a 0.1 ml aliquot of the test mixture to 0.9 ml of neutralizing broth and the whole solution mixed. The solution was left for 5 minutes to ensure the action of the active ingredient was effectively neutralized.

To quantify the surviving number of organisms in the neutralized test mixture, 4×0.025 ml aliquots were taken and spot plated onto the surface of dried TSA. The plates were then incubated for 24 hours at 37° C.

Counting and Calculation of Log Reductions

Limits of Detection (LOD)

Depending on the dilution parameters of a method and the techniques used to enumerate cells, specific limits of detection must be set to ensure reliable enumeration.

For counting of pour plates, colonies from the incubated plates were enumerated using the lower count limit of <10 and the upper count limit of >330. For example, if a plate had 7 visible colonies countable, <10 would be recorded and 10 would be used for the calculation. For the upper limit, if 407 colonies were counted on a plate, >330 would be recorded and 330 would be used for the calculation.

For spot plating, colonies from the incubated plates were enumerated using the lower count limit of <1 and the upper count limit of >150. For example, if a plate had 0 visible colonies, <1 would be recorded and 1 would be used for the calculation. For the upper limit, if 156 colonies were counted on a plate, >150 would be recorded and 150 would be used for the calculation.

When reporting the final log reduction value, if a lower limit of detection has been used to make the calculation a “>” value will be reported for example “>5.02 log reduction”, while if upper limit of detection has been used to make the calculation a “<” value will be reported for example “<2.92 log reduction”.

Enumeration and Calculation of N (Test Organism Suspension) and N₀

$$N = \frac{C}{( {n}_{1} + 0.1 {n}_{2} ) 1 {0}^{- 6}}$$

Where
C is the sum of viable count values
n₁ is the number of viable count values for the lower dilution, i.e. 10⁻⁶
n₂ is the number of viable count values for the higher dilution, i.e. 10⁻⁷
10⁻⁶ is the dilution factor corresponding to the lower dilution
For example:

$$N = \frac{168 + 213 + 20 + 25}{( 2 + 0.1 ⨯ 2 ) 1 {0}^{- 6}} = \frac{426}{2.2 ⨯ {10}^{- 6}} = 1.9 \; 363 ⨯ {10}^{8} = 1.9 ⨯ {10}^{8} cfu / ml$$

N₀ is the number of cells per ml in test mixture at the beginning of contact time. It is one-tenth of the weighted mean of N due to the tenfold dilution by the addition of the test product. In this example No is therefore 1.9×10⁷ cfu/ml.

Enumeration and Calculation of T (Test Mixture)
First, the mean average of cfu per 0.025 ml spots was established using the below calculation;

$$T = ( \frac{{d}_{1}}{4} )$$

Where
d₁ is sum of viable count values from 4 spots
Example:

$$T = \frac{29 + 25 + 31 + + 33}{4} = \frac{118}{4} = 29.5 cfu / 0.0 \; 25 ml$$

This was then multiplied by 40 to establish cfu/ml;
Example;

T=29.5×40=1180cfu/ml
During the neutralization step, the test mixture underwent a tenfold dilution. To account for this a final ten times multiplication is applied;

T=1180×10=11800=1.18×10⁴cfu/ml

Log Reduction Calculations (N₀₋ T)
Before calculating the log reduction both N₀ and T were converted into a logarithm base 10 value. For example;

N₀=1.9×10⁷=7.28 log 10

T=1.18×10⁴=4.07 log 10

To calculate the final log reduction the following calculation was used;

N₀−T=Log Reduction

For example;

7.28−4.07=3.21

The final log reduction for this example is 3.21

### Example 1

The test procedure outlined above was used to test for synergy between polyglyceryl-10 caprylate/caprate (PG10CC) and the various active ingredients listed in Table 1. Polyglyceryl glyceryl-10 caprylate/caprate showed little or no activity at 125 ppm, as is reported in Table 2 below. Varying concentrations were prepared and were tested at the times listed in Table 1 for the presence of Pseudomonas aeruginosa. As is shown in Table 2 below the amounts of the biocidal ingredient and PG10CC where there was an initial indication of synergy between the biocidal agent and PG10CC. The calculated Log reduction is in Pseudomonas aeruginosa for the various mixtures are shown in Table 2

TABLE 2

| Sample (Concentration - ppm) | Log Reduction |
|---|---|
| PGE Control (125 ppm) | <2.92 |
| Phenoxyethanol (10,000 ppm) | 3.88 |
| Phenoxyethanol (10,000 ppm) + PGE (12.5 ppm) | 4.85 |
| Benzisothiazoline (100 ppm) | 3.84 |
| Benzisothiazoline (100 ppm) + PGE (12.5 ppm) | 4.87 |
| Lactic acid (2000 ppm) | 4.03 |
| Lactic acid (2000 ppm) + PGE (125 ppm) | 4.92 |
| Zinc pyrithione (400 ppm) | 2.88 |
| Zinc pyrithione (400 ppm) + PGE (125 ppm) | 4.81 |
| Benzyl alcohol (3000 ppm) + PGE (12.5 ppm) | 4.81 |
| Benzyl alcohol (3000 ppm) + PGE (12.5 ppm) | 4.54 |
| Benzoic acid (2000 ppm) | <2.85 |
| Benzoic acid (2000 ppm) + PGE (25 ppm) | 4.12 |
| Glycolic acid (1000 ppm) | 2.85 |
| Glycolic acid (1000 ppm) + PGE (12.5 ppm) | 3.76 |
| chlorohexidine (64 ppm) | 3.44 |
| chlorohexidine (64 ppm) + PGE (37.5 ppm) | 4.5 |

While the invention has been described above with references to specific embodiments thereof, it is apparent that many changes, modifications and variations can be made without departing from the invention concept disclosed herein. Accordingly, it is intended to embrace all such changes, modifications, and variations that fall within the spirit and broad scope of the appended claims.

What is claimed is:

1. A preservative composition comprising
(i) a preservative agent, wherein the preservative agent comprises an acid compound, a phenolic compound, a sulfite, an iron chelator, an aromatic alcohol, a quaternary ammonium compound, a pyrone compound, an urea compound, an imidazole compound, an isothiazolinone compound, or a combination of two or more preservative agents; and
(ii) a polyglycerol ester,
wherein the polyglycerol ester is present in an amount to sufficiently increase the efficacy of the preservative agent as compared to the preservative agent alone, and the increase is greater than the additive effect of the biocidal activity of the preservative agent and polyglycerol ester taken alone, and
wherein the weight ratio of the polyglycerol ester to the preservative agent is in the range of 0.0001 to 2.0.

2. The preservative composition according to claim 1, wherein the weight ratio of the polyglycerol ester to the preservative agent is in the range of 0.001 to 1.5, such as in the range of 0.01 to 1.0.

3. The preservative composition according to claim 1, wherein the preservative agent comprises an iron chelator, said iron chelator comprises a pyrithione compound such as zinc pyrithione, sodium pyrithione or mixtures thereof, piroctone olamine, 2-pyridinol-1-oxide, N-hydroxy-6-octyloxypyridine 2(1H)-one, -hydroxy-6-octyloxypyridine 2(1H)-one ethanolamine salt or a mixture thereof.

4. The preservative composition according to claim 1, wherein the preservative agent is an acid compound, such as an acid, an ester of an acid or a salt of an acid.

5. The preservative composition according to claim 4, wherein the acid compound comprises benzoic acid, propionic acid, salicylic acid, sorbic acid, formic acid, undec-10-enoic acid, lactic acid, glycolic acid, and citric acid, or a salt thereof.

6. The preservative composition according to claim 1, wherein the preservative agent comprise a quaternary ammonium compound, such as an alkyl (C12-22) trimethyl ammonium compound, a benzethonium compound, or a mixture thereof.

7. The preservative composition according to claim 1, wherein the preservative agent comprises an alcohol, such as a lower alkyl alcohol or an aromatic alcohol.

8. The preservative composition according to claim 7, wherein the aromatic alcohol comprises phenoxy ethanol and wherein the lower alkyl alcohol comprises isopropanol.

9. The preservative composition according to claim 1, wherein the polyglycerol ester comprises a polyglycerol ester is derived from (a) a polyglycerol component built up from 2 to 12 molecules of glycerol, based on an average, and (b) a fatty acid comprising comprises a caprylic acid, capric acid, lauric acid, myristic acid, palmitic acid, stearic acid, arachidic acid, behenic acid, lignoceric acid, cerotic acid, oleic acid, or decaoleic acid.

10. The preservative composition, according to claim 9, wherein the polyglyceryl fatty ester comprises one or more of a polyglyceryl-10 laurate, polyglyceryl-10 decaoleate; polyglyceryl-3 monostearate; polyglyceryl-6 distearate, polyglyceryl-10 stearate; polyglyceryl-10 oleate; polyglyceryl-10 dipalmitate, or polyglyceryl-10 caprylate/caprate.

11. A method for increasing the efficacy of a preservative agent in an end-use formulation, said method comprising providing an end-use formulation and a preservative agent, adding an effective amount of a polyglycerol ester to the preservative agent and end use formulation to increase the efficacy of the preservative agent in the end-use formulation, as compared to an equal amount of preservative agent without the polyglycerol ester in the end-use formulation.

12. The method according to claim 11, wherein the polyglycerol ester is added to the preservative agent prior to adding the preservative to the end-use formulation or wherein the preservative agent is added to the end-use formulation prior to adding the polyglycerol ester to the end-use formulation or wherein the polyglycerol ester is added to the end-use formulation prior to adding the preservative agent to the end-use formulation or wherein the preservative agent and the polyglycerol ester are added to the end-use formulation concurrently.

13. An end-use formulation comprising a preservative agent according to claim 1, such as comprising a personal care formulation or a home care formulation.
